(19) United States
(12) Patent Application Publication
(10) Pub. No.: US 2011/0282929 A1
(43) Pub. Date: Nov. 17, 2011

(54) Computerized Request and Reward System

(76) Inventor: Wensheng Hua, Fremont, CA (US)

(21) Appl. No.: 12/767,629

(22) Filed: Apr. 26, 2010

Related U.S. Application Data
(60) Provisional application No. 61/172,541, filed on Apr. 24, 2009.

(51) Int. Cl. G06F 15/16

(52) U.S. Cl. 709/203

(57) ABSTRACT

This application relates to low cost, scalable computerized systems (and related methods) for users to set up requests and to reward users who helped to satisfy the requests. Users can send request to other users. Users can forward request to other users.

### CROSS REFERENCE TO RELATED APPLICATIONS

The present application is related to, and claims priority of, provisional patent application, entitled: “Link Based Promotion and Rewarding System”, with Ser. No. 61/172,541, filed on Apr. 24, 2009 The provisional patent application is hereby incorporated by reference in its entirety.

### BACKGROUND OF THE INVENTION

1. Field of the Invention

This application relates to low cost, scalable computerized systems (and related methods) for users to set up requests and to reward users who helped to satisfy the requests.

2. Discussion of the Related Art

EBay is builds an online market where users can bid and buy different goods. This invention can be embodied as a online system that users can setup requests and help other users to satisfy their requests. Technology of building web servers to serve web pages where user can do various actions such as sending and receiving message, send emails, etc., are used in one embodiment of the invention.

### SUMMARY

This application relates to low cost, scalable computerized systems (and related methods) for users to set up requests and to reward users who helped to satisfy the requests.

The request has very general meaning. It can be request of selling goods, or of selling service, or of doing business, or any general request. For example, the request can be selling digital cameras. For another example, the request can be finding customer for a realty service. For another example, the request is to find a job for the requester. For another example, the request can be sending an advertisement to people. For another example, the request can be find a place for good picnic. For another example, the request can be find a solution to a math problem. For another example, the request can be a request to find another request in the system.

The reward has very general meaning too. In some embodiments, the reward can be things with physical value, such as cash, credit, goods, services, discount, coupon, right to do things, etc. In some embodiments, the reward can also have virtual value, such as virtual money in a computer/network game or virtual good, credit in a virtual society, scores in a computerized system, etc. In some embodiments, reword can be simple as a thank-you email or letter. The reward can be a combination of these different kinds of reward too.

The user can have general meaning too. A user can be a human being. A user can also be a company. A user can be a computer system. A user can be any entity that can operate in system.

In preferred embodiment, the system allows users to do various actions. The actions includes: to set up requests, to send his/her/its requests to other users, to forward to other users the requests that are sent to the user or forwarded to the user, to sends leads to satisfy requests, to satisfy requests directly, to post comment about requests, to be rewarded, and so on. In general, a embodiment may allow some or all of these actions depends on its need. For example, in one embodiment a system might not allow user to satisfy request directly. User can only send leads to requests.

A user can help to satisfy the request in different ways. A user can help by sending leads to satisfy the request. A user can help by satisfying the request directly. A user can help by forwarding the request to other user or people outside the system. A user can help by posting a comment about request. A user can help in other ways also.

In a preferred embodiment, the system keeps record of user actions. In general, an embodiment may record all or some of these actions depending the actual need of the system. In preferred embodiment, these records (all or some of them) are used to reward users.

### [Messaging]

In a preferred embodiment, the system helps to send messages between users. The message include message of sending a request to other users, message of forwarding request to other users, message of sending leads to a request, message of request satisfied, message of user rewarded etc. The message can be a message within the compute system, for example, a message posted on one web page of the system. The message can be an email to other people. The message can be phone call. The message can be a letter. The message can be sent actively or passively. For example, when a message is sent actively, it can be an email sent to a user, or a message posted on a user's personal page. When a message is sent passively, it can be a message posted on a web page that is known to a certain user and the user can look it up when he/she wants to.

### [Rewarding System]

In a preferred embodiment, a user specifies how to reward other users (called reward schema, or payment schema) when the user sends the request to other users. The schema may include some or all information of, what actions should be reworded, how should the users be rewarded, on what condition should the user be reworded, and so on.

In a preferred embodiment, a user specify a reward schema when the user forward a request that was sent or forwarded to him/her/it to other users. The schema is about how to reward user when other user helps to satisfy the request forwarded. This reward schema may or may not be the same as the original reward schema for the request when the user receive the request that was sent or forwarded to him/her/it.

In a preferred embodiment, a user specifies how much reward he/she/it wants to get or to pay when he/she/it sends a lead to satisfy the request.

In one embodiment, a user specifies how much reward he/she/it wants to get or to pay when he/she/it satisfy a request.

In a preferred embodiment, after a user specify a reward schema, the reward schema is not allowed to change. The benefit is that the users who help or might help to satisfy the request know what reward he/she/it expects will not be changed.

In another preferred embodiment, after a user specify a reward schema, the reward schema is only allowed to increase the award. The benefit is that the users who help or might help to satisfy the request know what reward he/she/it receive will be as least larger than a certain value.

In a preferred embodiment, the rewarding system works in a hierarchical way. A request that is forwarded or sent to a user can be further forwarded to other users. In each step of sending/forwarding, the user specify a rewarding schema for how to reward the receiving user and the subsequent users. One benefit of the system is that it helps to distribute the reward the users that help to satisfy the request. For example, a user that forwards a request is rewarded according to the rewarding schema when he/she/it receives the request. This user in turn rewards (or equivalently to reward) the users according to the reward schema when he/she/it forwards the request. The difference between the rewards defined by these two reward schema is what this user actually earned in net. Another benefit is that it let each user to set up a reasonable trade off between what he/she/it gets and what other users get. For example, a user U may set up a request to sell a digital camera. He can earn 20 dollars for each camera he sells. He can set up the reward schema as he pays 10 dollars for each camera sold because he thinks there will be other users that will help him motivated by the reward. Hence, by this setup, he will earn 10 dollars in net for each camera sold. If he wants to sell more cameras, he might set the payment schema as paying 15 dollar per camera sale. This way he can only earn 5 dollars per camera in net, but he might get more camera sales. For instance, in previous example, a user, A, received a request to sell a camera and the rewarding schema is 8 dollars per camera sale. He can forward the request to another user, B, with rewarding schema of 7 dollar per camera sale. This way A will earn 1 dollar for each camera sale that was introduced by B. User can also send/forward one request to different users with different reward schema. For instance, in previous example, user A can forward the request to user C with reward schema of 6 dollar per camera sale because A knew that C is likely to buy a camera. Hence, A will earn 2 dollars for each camera sale introduced by C. It allows a user to claim how much reward he/she/it wants to get or pay when he sends a lead to the request. For instance, in previous example, user C sends a lead that he wants to buy a camera and he want to pay 2 dollars if there is a deal. If finally U did sell a camera from user C, user C will get 6 dollars by helping A to satisfy the request and will pay user U 2 dollars for the deal. Overall, the system encourages each user think about the trade off between what he/she/it gets verse what other users get. The knowledge about other user's need helps a user's ability of getting higher reward. When each user tries to maximize his/her/its own reward, request and supply are met in the system. This is one of the intrinsic values that the systems brings.

Note that the rewarding system discussed here can be very complex in general. For each request sending, request forwarding, lead sending, and other user action there can be a different reward schema can be set up. In addition, since each user can forward/send each request to multiple users, the number of users and actions associated with each request can grow exponentially fast. This fast growing nature is beneficial because it enables very efficient information delivery. For a system to operate well, it has to deal with the vast complexity. Modern computer technologies make the systems much easier and cheaper to implement than using manual systems.

In some embodiments, complexity of the reward system can be further reduces by constraining what reward schema each user can use when he/she/it sends/forwards requests. In different embodiments, as long as each user can adjust what the receiving user and the subsequent receiving users can get, it can benefit from the invention.

### [Request Link]

A request link is the list of sequent users that receives a request when the request is received. For example user A create a request. A sends the request to user B and user C. Then user B forwarded the request to user D and user E. User C forwarded the request to user F. User E sends a lead to the request. User List [B, D] is a request link when D receives the request. User list [B, E] and [C, F] are also request links when E and F receive the request. [B] is the request link when B receive the request.

In one of the preferred embodiment, reward schema is based on request link. For example, when a request is satisfied, only users that are on the request list for that request is rewarded. One advantage of using request list is to make the reward system simple.

### [Reward Distribution]

In a preferred embodiment, the system helps to distribute rewards to users. The rewards are distributed based on records of user actions and the reward schema that were set up by the users. For example, the system takes credit card payment from the user who sets up the request, and pays cash to users who helped to satisfy the request by sending lead to the request or by forwarding the request using PayPal. In preferred embodiments, the rewards are designed as actions that can be automatically evacuated by a computer or a computer system.

Note that in some embodiments, the system can also do not handle reward distribution and let the users to distribute reward themselves.

### [Spam Control]

Since each user can sent/forward requests to many users, the number of messages sent between users can grow exponentially fast. To get more reward, a user is also motivated to forward the request to as many users as possible. If not well controlled, there will be a lot of unnecessary messages sent in the system. A user will have to spend a lot time to deal with the irrelevant messages, which makes the whole system inefficient. These irrelevant messages are called spam messages.

In a preferred embodiment, methods are used to reduce spam messages. One method used is to only allow user to send/forward requests to users that he/she/it had already known. For example, a user is only allowed to send/forward requests to his/her friends in a social network. Another method used is to require each user to specify from whom he want to receive request from. Another method is to set up a limit on how many times that a request can be forwarded. Another method is to enforce each user to pay a cost when send/forward request. The cost here has very general meaning similar to that of reward. The cost can be a certain cash payment. The cost can be usage of a quota. The cost can be a reduction of a certain score.

### [System Profit]

The system can make profit itself in several ways. The system can profit by charging a fee. For example the system can charge a fee for each cash rewarding action. For example, one way to charge fee is to charge a percentage of the cash that is received by each user. Another way is to charge a fixed fee from the requester. The system can also profit by selling tokens to users. The system can also make profit by sending advertisement to the users. One way to do advertisement is to display advertisement on user's personal web page. Since the system keeps record about what users requested and what users did to satisfy other user's requests, targeted advertisement can be delivered.

### [Token Based Reward System]

In one embodiment, a token based reward system is used. The reward schema used in the system is based on the tokens. The token based reward schema may not be the most general schema (hence, may not have the most flexibility), but it makes it much easier for users to understand and to use the system.

Tokens are limited resource for each user. A user cannot do action if he/she/it does not have enough token needed by the action.

Each user can obtain tokens in several ways. A user might be given some limited number of tokens from the system when the user signs up. A user might be given token by the system through some actions (for example, to introduce new users, to log in, use the system to set up request, forward request). A user might get token as part of the reward. A user might buy tokens from the system. In some embodiment, a user might get token in other ways, such as buy token from other users in a virtual token trading market in the system.

Any user can set up a request. The user who set up the request is called the requester. When he sets up the request, he has to define:
a) what the request is, including if the request is repeatable. The request can be one time only. For example a requester might request to find one job. There are some cases where a user can set up a repeatable request. For example, a user can set up a request for selling digital cameras. He will pay each time a camera is sold. He might stop (cancel) the request when he sell all the cameras that he has.
b) the reward type, typically in the amount of cash, can also be other kind of reward, for example tokens. For another example, a percentage of the sale amount, or a percentage of the profit.
c) what is rewarded, it may reward each satisfaction of the request, reward each lead for the request, reward each forward of the request and any combination of these.
d) how much should be rewarded for different actions.
e)the max number of tokens on any request link. In some embodiments, the requester can put different token limit on different links.
f) if the request can be satisfied directly. For example, if a user setup a request to sell camera, a user may satisfy the request directly by buying the camera. For another example, if a user setup a request to find a job, he may not allow to satisfy the request directly. He will read the leads to find a job himself, and probably go through the interview process and then get a job.

The requester can send the request to other users that allow him to send request to. The requester spends at least one token each time he/she/it sends a request.

Each user that receives a request can
1, know the maximum number of tokens that can be put on the request link that he/she/it receives the request through, the total number of tokens that is already put on the request link.
2, forward the request to other users that allows the user to forward. A user is required to put at least one token on the request link when forward the request. The user is not allowed to forward the request if the total number of tokens on the request link is larger then the maximum number of tokens on a request link. This way, the maximum number of forwards is constrained. (In a less preferable implementation, user is not required to put at least one token on each forwarded request link. The request link will still be forwarded, but the user will not be rewarded for that request link even if it become successful later). If a user forwards the request to multiple users, multiple request links are created, one for each forward.
3, Send one or more leads to the requester. On each lead the user put tokens. These tokens are counted as tokens on the link, which is limited by the max number of tokens on the link. The user is required to put at least one token on each proposal. (In less preferable, implementation, he is not required to put token, but will not be rewarded either, similar to the request forwarding case).
4, A user can satisfy a request directly if allowed by the requester.

When the requester receives a proposal, he/she/it might make a deal with the proposal (that means the request is satisfied), or wait for more proposals.

Once a request is satisfied, the requester should pay for the award he promised for the deal. The reward is divided among all the users on the request link that lead to the deal, i.e. the successful request request link. Each user receive award proportion to the number of tokens that he put on the request link.

If the requester set up request schema that rewards forward action or lead action, or other action, the reward is sent each time such actions happens. The reward is also divided among all the users on the request link proportional to the number of tokens that the users put on the link.
5, the requester may cancel the request.
6, when a request is canceled or when a non-repeat request is satisfied, all the users that received the request are informed. The tokens that users put on the request (including tokens put on the request links) are not returned. Note that the reason that these tokens are not returned is to add a cost to the user for spam control. In other embodiments, the system can return part or all of the tokens.
7, the system charge a percentage a fee for each reward action.

### AN EXAMPLE

To demonstrate how the token based reward system works, let us go through an example as shown in FIG. 1.

Vin was looking for a job. He thought it was very import for him and he decided that he was going to pay $1000 dollars for the people who helped him to find a job. To control how people was going to be rewarded, he set up a token limit: the maximum was 10 tokens per request link.

Then, Vin asked people, preferably his friends, to help him. He asked two of his friends, Tom and Larry to help him. He told them that the reward was $1000 and token limit was 10. Note that two request links are automatically created when the request is sent the two users. He pays the system 1 token for each requests he created.

Tom found that he could not find a job for Vin himself but his friend John and Jones might. So he forwarded the request from Vin to John and Jones. When Tom forwarded the requests he puts tokens on them, which would be used to decide how much reward Tom is going to get when the request is satisfied. Tom chose to put 1 token on the request link that he forwarded to John and 2 tokens on the request link that he forwarded to Jones.

John further forked and forwarded Vin's request to Mike, Lili, and Nancy. He put 2 tokens on the link forwarded to Mike, 1 tokens on the link forwarded to LiLi and 3 token on the link forwarded to Nancy. Nancy's company was hiring and she sent a lead, “My company is hiring”, to Vin (through John) and she put 6 tokens on the lead. She could not put any more tokens on the link (including lead) because she there are already 4 tokens (1 from Tom and 3 from John) on the link and the total limit is 10.

Larry found that his company was hiring and he sends a lead to Vin saying “My company is hiring”. He put 2 tokens on the lead. He also forked and forwarded the request link to Rob and Kelly. Larry put 3 tokens on the request link to Rob and put 5 tokens on the request link to Kelly.

Then Vin considered the two leads that he received, one from Larry and another one from Nancy. He interviewed with both of the companies and he got job offers from both of them. Vin decided to work at Nancy's company. So his request is satisfied. Then, he split the reward his promised to the three people that on the request forwarding link that got him the job: Tom (put 1 token), John (put 3 tokens) and Nancy (put 6 tokens). He split the reward money proportional to the number of tokens that people put onto the link, including the proposal. There are totally 10 tokens on the link, and Tom put on 1 token and hence he received 1/10 of the reward, $100. Similarly, John received 3/10 of the reward, $300 and Nancy received 6/10 of the reward, $600.

It possible that the total number of tokens on a link (including the proposal) is less than the token limit set by the requester. For, example, if Vin had worked for Larry's company, the total number of tokens on the link would be 2, all of which belonged to Larry. Hence, Larry would get 2/2 of all the reward, i.e. $1000. Upon satisfying the request, all the tokens that were put on the different links were collected by the system and the users no longer have them. The system rewarded some tokens back to the users on the successful link. The system rewarded 2 tokens to Tom, 6 tokens to John, and 12 tokens to Nancy, i.e. the reward was the double of the amount of tokens that the users had put on the successful link. If Vin had not gotten a job for a while (for example, 3 months), and he had decided to cancel the request, he could. If that had happened, nobody would be rewarded money by Vin and the system would collect all the tokens.

The present invention is better understood upon consideration of the detailed description below in conjunction with the accompanying drawings.

### BRIEF DESCRIPTION OF THE DRAWINGS

FIG. 1. shows an example of a case in a token based reward system.

FIG. 2, shows the structure of the system as a web site.

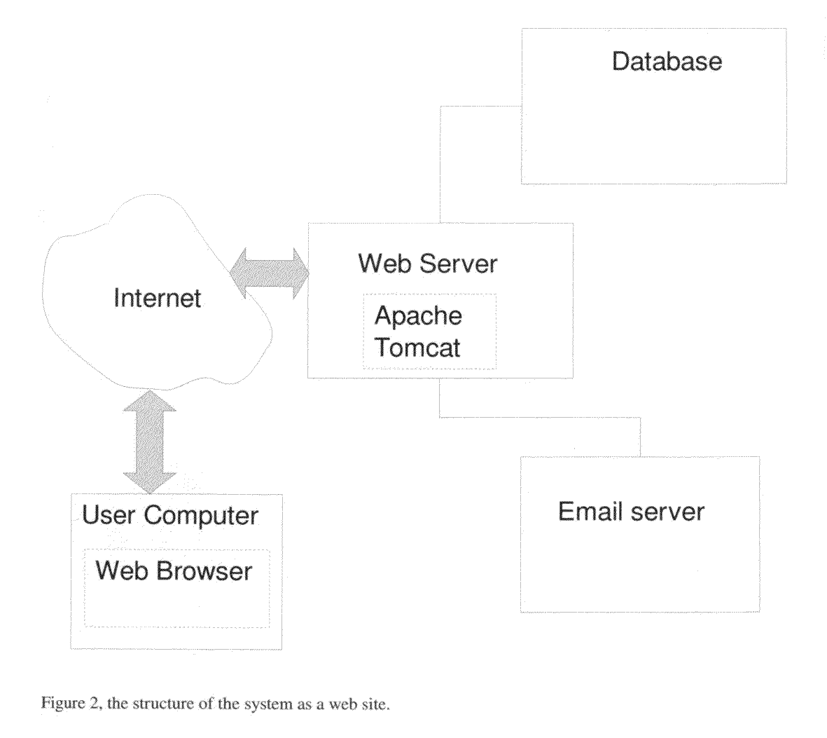

FIG. 3, shows the block diagram about how to construct forward link.

### DETAILED DESCRIPTION

Although the following detailed description contains many specifics for the purpose of illustration, anyone of ordinary skill in the art will appreciate that many variations and alternations to the following details are within the scope of the invention. Accordingly, the following embodiments of the invention are set forth without any loss of generality to and without imposing limitations upon, the claimed invention.

### [Web Site]

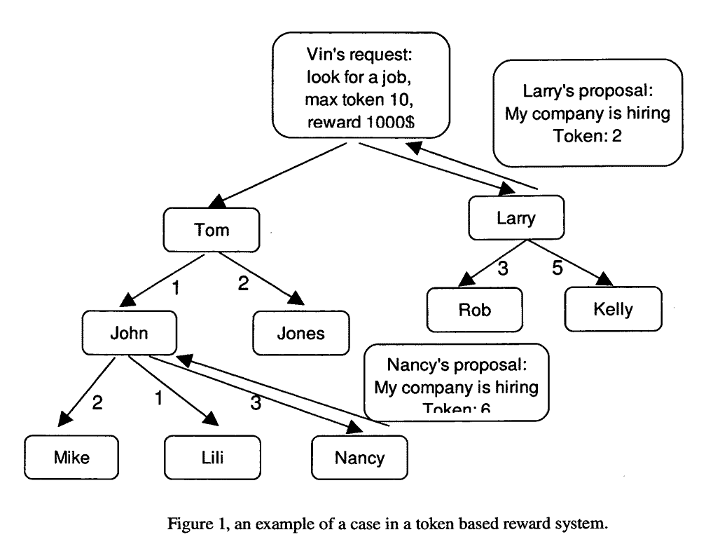

In one embodiment of the invention, the system can be build as a web site on the Internet as shown in FIG. 1. A web server is used to serve web pages to the Internet. A user can use a web browser on a computer to access the web pages on the web site. The server uses a relational database, such as MySql database to record user actions and other user information. The server also talks to email server to send and receive emails to the users. The web server can use many different choices to serve the web page. For example Apache Tomcat software can be used.

The embodiment uses the token based reward system as previously described.

Each user has a user name and password. The user name and password were chosen by the user when user signs up for using the system.

Each user has a profile. The profile data contains personal information about a user, such as age, name, email address, mail address etc. Each user is allowed to change his/her/its profile.

Each user has an account in the system. The account stores how much cash the user has and how many tokens the user has. Each user can get cash from his account or put cash to his account. The cash transactions are implemented using credit card payment systems or PayPal service. A user can buy tokens from the system using his/her/its cash.

The system also has an account itself, called system account. The system account stores how much cash the system has. The system owner can get cash from or put cash into this account. The system account can gain cash by selling tokens or by charging fee from users. The system has unlimited number of tokens.

Each user can create request, send request, forward request, send lead, and satisfy request(if allowed by the requester) on web pages according to the token based rewarding system.

Each user also keeps a list of users from those the user accepts requests (including sent request or forwarded request). This list is called the accept list.

Each user can send message to other users to require other user to add him/her/it to the accept list. The message can be sent through email (through the mail server) or the system's internal messaging system.

### [Web Pages]

There many ways to design the user web pages. One way of designing the web page is as following. The system has a main web page where users can log in. For new users, that do not have accounts, the main page has a link to a sign up page, where new users can sign up. While signing up, a user need to provide a unique user name and create a password for it. For users that already have a password, the main page will direct them to a personal page if they provide correct password.

A user's personal page contains multiple subpages, including profile subpage, account subpage, friend subpage, my request subpage, received request subpage, message subpage. A user can log out by click on a log out button on the personal page.

Profile subpage stores personal profile information, such as age, name, email address, mail address etc. A user is allowed change his/her/its profile on this page.

The account subpage contains information about how much cash and how many tokens the user have. User can get cash from his account or put cash into his account on this page. A user can buy tokens from the system on this page too.

The friend subpage has a list of users that the user allows to receive requests from. The user can add other users to this list on this page. The page also has a list of users that the user is allowed to send/forward request to.

The my request subpage contains the requests that the user creates. It has a list of created requests. For each request, the user can view the request definition information (what is the request about, reward, maximum token, repeatable or not, etc.), to whom the request is forwarded to, and the leads for the request. On this page a user can:
create a new request by providing the request definition information;
send a request to other users (need to use one token);
make deal with a lead.

The received request subpage contains the request that the user received. It has a list of received requests. For each request, the user can view the request definition information, the requester of the request, from whom the request was forwarded from, to whom the request was forwarded to (and the number of tokens used), the total token put on the request link before the user.

On this page a user can:
forward the request to other users (need to put tokens on the request link);
send lead to the requester (need to put tokens on the request link);
satisfy a request.

The message subpage contains messages that the user sent and received. On this page a user can send a system message to another user which will be posted on the other user's message page. On this page a user can also send a message to another user using email, where an email will be sent to the other user's email account.

### [Server Side]

On the server side, the server software uses a relational database, for example, a MySQL database, to store information. The database contains following major tables.

User table: contains user Id, user name, password.

User profile table: contains user profile information, including user Id, user's real name, address, email address, etc.

User account table: contains user id, user cash and user token.

User friend table, (to record if a user allows other user to send request, if there is a record from a send user id to a receive user id, the user with the send user id is allowed to send or forward request to the user with the receive user id): contains send user id, receive user id.

Request table: contains request id, request description, reward for satisfaction, reward for lead, reward for forwarding, if the request is repeatable, max token per request link, if the request is canceled, requester id, request time.

Request Send table: contains request id, receiver id, token used.

Request Forward table: contains request id, previous forward id (null if not available), forward sender id, forward receiver id, number of tokens used.

Request lead table: contains request id, previous forward id (null if not available), sender id, number of token used.

### [Server Action]

When a server serves a subpage of the user's personal page, it just look up the information needed by the subpage from the database and serve those information through the web page. Details about serving those web pages is well known. For example, it can be implemented using JSP and Java servelet technologies.

How does the server operate when a user does a certain action can also be implemented using the well known common web server technologies. For example AJAX technologies can be used to handle the interaction between the serve and the user. Here is the outline for several major operations.

Create request:

The request definition information is sent from the user to the server through the web page. The server then:
1, creates a request id for the request, obtains request time, obtains the requester id, and uses these information and the request definition information to create a record in the request table.
2, informs the user that new request is created

Send request:

The user sends request id and receiver user name, and the number of token used to the server.

The server then:
1, looks up the receiver id using user name,
2, obtains the sender's user id
3, checks the sender has enough tokens. If there is not enough, informs the sender that the action failed.
4, checks if the user is allowed to send request to the receiver. If not, informs the sender that the action failed.
5, removes tokens from the sender's record in account table
6, creates a record in Request Send Table.
7, informs the user that the action is done.

Forward request:

The user sends request id, previous forward id (null if not available), forward sender id, forward receiver user name and number of token used to the server through web page.

The server then,
1, looks up the receiver id using user name,
2, checks the sender has enough tokens. If there is not enough, informs the user that the action failed.
3, constructs request link and finds the tokens put by different users on the request link, and check if the total token put on the link is larger than the token limit. If so, inform the user that the action failed.
4, checks if the user is allowed to forward request to the receiver. If not, informs the user that the action failed.
5, removes tokens from the sender's record in account table
6, creates a record in Request Forward table
7, distributes reward for the forward if reward for forward field is not zero in the request table.
8, informs the user that the action is done.

Send lead to request:

The user send request id, previous forward id (null if not available), sender id, and number of token used to the server through web page.

The server then,
1, checks the sender has enough tokens. If there is not enough, inform the sender that the action failed.
2, constructs request link and find the tokens put by different users on the request link, and check if the total token put on the link is larger than the token limit. If so, inform the user that the action failed.
3, removes tokens from the sender's record in account table
4, creates a record in Request Lead table
5, distributes reward for the forward if reward for lead field is not zero in the request table.
6, informs the user that the action is done.

Confirm deal:

The requester send information about the request id, lead id to the server

The server then,
1, looks up the lead in the Request Lead table
2, distributes reward for the forward if reward for satisfaction field is not zero in the request table.
3, informs the user that the action is done.

Satisfy request:

The user send request id, previous forward id (null if not available) to the server

The server then:
1, distributes reward for the forward if reward for satisfaction field is not zero in the request table.
2, informs the user that the action is done.

Distribute rewards:

The server
1, constructs Request Link and finds the tokens put by different users on the request link.
2, calculates the reward each user pay or receive.
3, up dates user account table.

Construct Request Link and find the tokens put by different users on the request link:

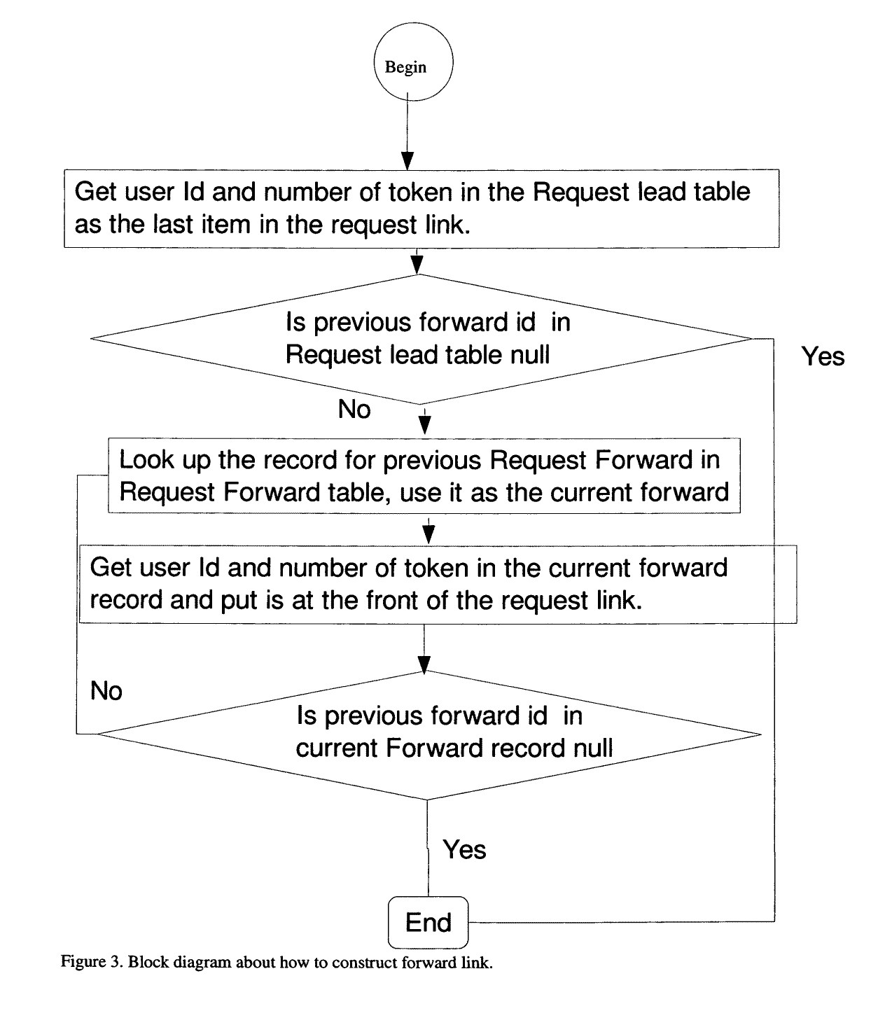

This operations involves recursive lookup of Request Lead table, Request Forward table and Request table. For example, how to construct request link in from a record in Request Lead table is shown in FIG. 3. How to construct request link from a record in Request Forward table can be done similarly.

1: A computer system that helps users to set up request and reward uses who helps to satisfy requests, that compromises:
a storage device that records user data and system data,
a computer or compute system that processes data and communicates with users,
means that allows user to specify the request,
means that allows user to send request to other users,
means that allows user to forward request to other users,

2: as in claim 1, wherein means that allows user to specify reward schema,

3: as in claim 2, wherein means that allows user to specify reward schema when send request to other user,

4: as in claim 2, wherein means that allows user to specify reward schema when forward request to other users,

5: as in claim 1, wherein means to reduce irrelevant messages, or irrelevant sending of requests, or irrelevant forwarding of requests,

6: as in claim 1, wherein means to require user only allowed to send or forward request to users that allows the sender to do so,

7: as in claim 6, wherein means to require user to spend a cost when send or forward a request,

8: as in claim 6, wherein means to require that a request can only be sent or forwarded by a limited number of times,

9: as in claim 8, wherein means to control the request link to have limited length,

10: as in claim 1, wherein means to distribute reward to users that helps to satisfy the request,

11: as in claim 1, wherein the reward is proportional to the resource that each user spend when forwarding the request or sending a lead to the request,

12. as in claim 11, wherein the reward is only sent to users on the request link.
